(19) United States
(12) Patent Application Publication
(10) Pub. No.: US 2024/0274146 A1
(43) Pub. Date: Aug. 15, 2024

(54) ADVANCED SPEECH ENHANCEMENT SYSTEM AND A METHOD PERFORMING THE SAME

(71) Applicant: SKYWORKS SOLUTIONS, INC., Irvine, CA (US)

(72) Inventors: Meenakshi Barjatia, Beaverton, OR (US); Megan Catharine Frantz, Milwaukie, OR (US)

(21) Appl. No.: 18/436,299

(22) Filed: Feb. 8, 2024

Related U.S. Application Data
(60) Provisional application No. 63/444,374, filed on Feb. 9, 2023.

(51) Int. Cl. G10L 21/0232

(52) U.S. Cl. CPC G10L 21/0232

(57) ABSTRACT

A method for processing audio signals is presented, wherein the method includes receiving a first audio signal including a background noise; receiving a second audio signal with a reduced signal level from the first audio signal; detecting a level difference between the first audio signal and the second audio signal in each of a plurality of predetermined frequency bands; estimating a signal-to-noise ratio (SNR) of the second audio signal for each of the plurality of frequency bands based on the detected level difference; and adjusting a mixing ratio of the first audio signal to the second audio signal based on the estimated SNR independently for each of the plurality of frequency bands to generate an output audio signal having a balanced SNR throughout the plurality of frequency bands.

### CROSS-REFERENCE TO RELATED APPLICATIONS

The present application claims priority under 35 U.S.C. § 119(e) to U.S. Provisional Application No. 63/444,374, titled ADVANCED SPEECH ENHANCEMENT SYSTEM AND A METHOD PERFORMING THE SAME, filed Feb. 9, 2023, which is hereby incorporated by reference in its entirety for all purposes.

### BACKGROUND

### Field

Aspects and embodiments of the present disclosure relate to a method for audio processing and a system performing the same for generating audio sound.

### Description of Related Technology

In speech communication systems, speech signals to be analyzed are usually noisy signals containing speech portions contaminated with noise other than speech. The presence of environmental noise may seriously affect the performance of the speech communication system.

Speech signals can be generally divided into silence segments, unvoiced segments, and voiced segments. The silence segment is a background noise segment, and the average energy is the lowest; the voiced segment is a voice signal segment corresponding to vocal cord vibration, and the average energy is highest; the unvoiced segment is a speech signal segment emitted by the friction, impact or explosion of air in the oral cavity, and the average energy is between the former two.

There are a lot of different speech enhancement methods to extract as clean of speech signals as possible from contaminated speech signals. Known speech enhancement algorithms can be theoretically divided into spectral subtraction, statistical model-based, and signal subspace-based speech enhancement algorithms. The spectral subtraction algorithm is a traditional speech enhancement algorithm, and is simple in calculation and good in real-time performance. Spectral subtraction has been adopted by many practical digital speech processing systems because of its simplicity and effectiveness. Although the traditional spectral subtraction method and the improved spectral subtraction method are simple to implement, require a relatively small amount of calculation, and can inhibit noise to an extent, when the signal-to-noise ratio is low, speech distortion is easily caused, new noise is possibly inserted into the signal, and human perception of the speech may be influenced. Due to the overlapping characteristic of noise and voice signals in the frequency domain, distortion of the original voice signal is inevitably caused while noise is eliminated and the signal-to-noise ratio of the voice signal is improved.

### SUMMARY

According to at least one aspect of the present disclosure, a method for processing audio signals is presented, the method comprising: receiving a first audio signal including a background noise; receiving a second audio signal with a reduced signal level from the first audio signal; detecting a level difference between the first audio signal and the second audio signal in each of a plurality of predetermined frequency bands; estimating a signal-to-noise ratio (SNR) of the second audio signal for each of the plurality of frequency bands based on the detected level difference; and adjusting a mixing ratio of the first audio signal to the second audio signal based on the estimated SNR independently for each of the plurality of frequency bands to generate an output audio signal having a balanced SNR throughout the plurality of frequency bands.

In some examples, the method further comprises outputting the output signal with the adjusted mixing ratio for each of the plurality of frequency bands. In some examples, the step of adjusting the mixing ratio includes increasing a portion of the first audio signal in a predetermined frequency band where a SNR of the second audio signal is relatively higher than the other predetermined frequency bands. In some examples, the step of adjusting the mixing ratio includes decreasing a portion of the first audio signal in a predetermined frequency band where a SNR is relatively lower than the other predetermined frequency bands. In some examples, the second audio signal is obtained by a speech enhancement device that enables to reduce the background noise included in the first audio signal. In some examples, the step of adjusting the mixing ratio is performed periodically according to a pre-configured period of time. In some examples, the first audio signal is a raw speech signal of a user.

According to at least one aspect of the present disclosure, an adjustment device for an advanced speech enhancement system is presented, the adjustment device comprising: a first input node configured to receive a first audio signal including a background noise; a second input node configured to receive a second audio signal with a reduced signal level from the first audio signal; a detection module configured to detect a level difference between the first audio signal and the second audio signal in each of a plurality of predetermined frequency bands; an estimation module configured to estimate a signal-to-noise ratio (SNR) of the second audio signal for each of the plurality of frequency bands based on the detected level difference; and an adjustment module configured to adjust a mixing ratio of the first audio signal to the second audio signal based on the estimated SNR independently for each of the plurality of frequency bands to generate an output audio signal having a balanced SNR throughout the plurality of frequency bands.

In some examples, the device further comprises an output node configured to output the output signal with the adjusted mixing ratio for each of the plurality of frequency bands. In some examples, the adjustment module is configured to increase a portion of the first audio signal in a predetermined frequency band where a SNR of the second audio signal is relatively higher than the other predetermined frequency bands. In some examples, the adjustment module is configured to decrease a portion of the first audio signal in a predetermined frequency band where a SNR is relatively lower than the other predetermined frequency bands.

In some examples, the second input node is suitable for being connected to a speech enhancement device that enables to reduce the background noise included in the first audio signal such to receive the second audio signal. In some examples, the adjustment device is configured to adjust the mixing ratio periodically according to a pre-configured period of time. In some examples, the first audio signal is a raw speech signal of a user.

According to at least one aspect of the present disclosure, an advanced speech enhancement system is presented, the system comprising: a speech enhancement device configured to receive the first audio signal and output the second audio signal having improved SNR; and an adjustment device including a first input node configured to receive a first audio signal including a background noise, a second input node configured to receive a second audio signal with a reduced signal level from the first audio signal, a detection module configured to detect a level difference between the first audio signal and the second audio signal in each of a plurality of predetermined frequency bands, a estimation module configured to estimate a signal-to-noise ratio (SNR) of the second audio signal for each of the plurality of frequency bands based on the detected level difference, and an adjustment module configured to adjust a mixing ratio of the first audio signal to the second audio signal based on the estimated SNR independently for each of the plurality of frequency bands to generate an output audio signal having a balanced SNR throughout the plurality of frequency bands.

In some examples, the adjustment device further comprising an output node configured to output the output signal with the adjusted mixing ratio for each of the plurality of frequency bands. In some examples, the adjustment module of the adjustment device is configured to increase a portion of the first audio signal in a predetermined frequency band where a SNR of the second audio signal is relatively higher than the other predetermined frequency bands. In some examples, the adjustment module of the adjustment device is configured to decrease a portion of the first audio signal in a predetermined frequency band where a SNR is relatively lower than the other predetermined frequency bands. In some examples, the second input node of the adjustment device is connected to the speech enhancement device. In some examples, the adjustment device is configured to adjust the mixing ratio periodically according to a pre-configured period of time. In some examples, the first audio signal is a raw speech signal of a user.

### BRIEF DESCRIPTION OF THE DRAWINGS

FIG. 1 shows an example of an estimated amplitude of the noise spectrum by a noise spectrum mean according to a conventional manner;

FIG. 2 shows an example of a result of using a Wiener filter to subtract the noise spectrum mean from an input signal according to a conventional manner;

FIG. 3 is a schematic diagram of an advanced speech enhancement system according to an embodiment of the present disclosure;

FIG. 4 shows an analysis result of high accuracy for the SNR estimation according to an embodiment of the present disclosure;

FIG. 5 is a schematic diagram of the adjustment device for an advanced audio processing system according to an embodiment of the present disclosure;

FIG. 6 is a flow chart illustrating a method for processing audio signal according to an embodiment of the present disclosure;

FIG. 7 is an example computing environment that can implement different method steps and algorithms described herein;

FIG. 8A is a schematic diagram of one embodiment of a packaged module;

FIG. 8B is a schematic diagram of a cross-section of the packaged module of FIG. 8A taken along the lines 8B-8B; and

FIG. 9 is a schematic diagram of one embodiment of a phone board.

### DETAILED DESCRIPTION OF EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrate d in a drawing and/or a subset of the elements illustrated in a drawing. Further, some embodiments can incorporate any suitable combination of features from two or more drawings.

The performance of speech communication systems in applications such as hands-free telephony degrades considerably in adverse acoustic environments. The presence of noise can cause a loss of intelligibility as well as the listener's discomfort and fatigue. Speech enhancement methods seek to improve the performance of these systems and to make the corrupted speech more pleasant to the listener. These methods are also useful in other applications such as automatic speech recognition.

The removal of additive noise from speech has been an active area of research for several decades. Numerous methods have been proposed by the signal processing community. Among the most successful signal enhancement techniques have been spectral subtraction, Wiener filtering, and signal subspace methods. Although these techniques improve speech quality, they suffer from annoying residual background noise, including tones at random frequencies, resulting from poor estimation of the signal and noise statistics. The quality and the intelligibility of the enhanced speech signal could be improved by reducing or in better cases eliminating this kind of residual background noise.

Many variations have been developed to cope with the residual background noise phenomena, including spectral subtraction techniques based on masking properties of the human hearing system. A number of methods have been developed to improve intelligibility by modeling several aspects of the enhancement function present in the auditory system. These attractive methods use a noise masking threshold (NMT) as a crucial parameter to empirically adjust either thresholds or gain factors. This auditory system is based on the fact that the human car cannot perceive additive noise when the noise level falls below the NMT.

Masking is the phenomenon where the perception of one sound is obscured by the perception of another. Masking occurs when two sounds occur at the same time or when separated by a small delay. The former is known as simultaneous masking (or frequency masking) and the later as temporal masking (or non-simultaneous masking). Temporal masking can be further classified as forward masking and backward masking. For example, in case of the simultaneous masking, i.e., a weak signal is made inaudible by a strong signal occurring simultaneously, this phenomenon is modeled via a noise-masking threshold, below which all spectral components are inaudible. The masking-based speech enhancement approach basically incorporates the noise masking properties into a speech enhancement algorithm.

It has been well established that noise masks tones more effectively than tones mask noise. Researchers have suggested that the bandwidth and temporal characteristics of the target and masker contribute to this asymmetry. Excitation patterns (EP), which represent the output of the auditory filters, are intrinsically associated with auditory masking. If the EP of a target signal falls below that of a masker, the target stimulus is no longer audible. Coding applications have used these properties to compress audio and suppress noise. Specifically, the EP is calculated by convolving the basilar membrane spreading function with the critical band densities. The EP is adjusted in accordance with the notion that tones and noise are asymmetrical maskers. This adjustment is the “relative threshold offset” term. In several conventional manners as an example, for a tone masking a noise, the EP is reduced by a factor of (14.5+i) dB where i is the critical band number. For noise masking a tone, the EP is reduced by factor of 5.5 dB across critical bands. Both calculations may be scaled, based on the degree to which a signal is noise-like versus tone-like (tonality), by computing a spectral flatness measure (SFM). The SFM is the ratio of the geometric mean of the power spectrum to the arithmetic mean of the power spectrum. A SFM approaching 1 indicates that the signal is tone-like; a SFM approaching 0 indicates that the signal is noise-like.

Hereinafter, one example of a conventional filtering method is introduced.

Without limitation of generality, let the noisy signal be expressed as:

$$y ( n ) = x ( n ) + d ( n ) , \qquad ( 1 )$$

where x(n) is the clean signal and d(n) is the additive random noise signal, uncorrelated with the original signal. Performing a FFT on the observed signal yields:

$$Y ( m , k ) = X ( m , k ) + D ( m , k ) , \qquad ( 2 )$$

where m=1, 2, . . . , M is the frame index, k=1, 2, . . . , K is the frequency bin index, M is the total number of frames and K is the frame length, and Y (m,k), X(m,k) and D(m,k) represent the short-time spectral component of y(n), x(n) and d(n), respectively.

Basic speech enhancement methods involve estimating every frequency component of the clean speech \hat{X} (m,k) by:

$$\hat{X} ( m , k ) = H ( m , k ) Y ( m , k ) , \qquad ( 3 )$$

where H(m,k) is the noise suppression filter (denoising filter) chosen according to a suitable criterion. The error signal generated by this filter is:

$$e ( m , k ) = \hat{X} ( m , k ) - X ( m , k ) = ( H ( m , k ) - 1 ) X ( m , k ) + H ( m , k ) D ( m , k ) . \qquad ( 3 a )$$

The first term in Eq. (3a) describes the speech distortion caused by the spectral weighting that can be minimized using H(m,k)=1. The second term in equation (3a) is the residual noise distortion that can be minimized if the spectral weighting H(m,k)=0. Musical residual noise results from the pure tones present in the residual noise.

In general, the noise suppression filter can be expressed as a function of the a posteriori SNR γ (m,k) and a priori SNR ξ(m,k) given by:

$$γ ( m , k ) = \frac{{\vert Y ( m , k ) \vert}^{2}}{{Γ}_{d} ( m , k )} , \qquad ( 4 )$$

$$ξ ( m , k ) = \frac{{Γ}_{x} ( m , k )}{{Γ}_{d} ( m , k )} , \qquad ( 5 )$$

where Γ_{d}(m,k)=E{|D(m,k)|²}, by definition, is the noise power spectrum, an estimate of which can be made easily during speech pauses and Γₓ(m,k)=E{|X(m,k)|²}.

The instantaneous SNR can be defined as:

$$ϑ ( m , k ) = γ ( m , k ) - 1. \qquad ( 6 )$$

An estimate \hat{ξ} (m,k) of ξ(m,k) may be given by the well-known decision-directed approach and may be expressed as:

$$\hat{ξ} ( m , k ) = max ( α \frac{{\vert H ( m - 1 , k ) Y ( m - 1 , k ) \vert}^{2}}{{Γ}_{d} ( m , k )} + ( 1 - α ) {P}^{′} [ ϑ ( m , k ) ] , {ξ}_{m i n} ) , \qquad ( 7 )$$

where P′[x]=x if x≥0 and P′[x]=0 otherwise.

Several variants of the noise suppression gain H(m,k) have been reported in the literature; here, without loss of generality, the gain function is chosen as the Wiener filter expressed as:

$$H ( m , k ) = ξ ( m , k ) 1 + ξ ( m , k ) . \qquad ( 8 )$$

Although there are many algorithms in the literature in this field, the Wiener filter may be chosen as an example since it is the most fundamental approach, and many algorithms are closely connected with this technique. Moreover, the Wiener filter introduces less background noise than spectral subtraction methods.

The temporal-domain denoised speech is obtained with the following relation:

$$\hat{X} ( n ) = IFFT ( \vert \hat{X} ( m , k ) \vert \cdot {e}^{j a rg ( Y ( m , k ) )} ) . \qquad ( 9 )$$

Since human perception is mostly phase insensitive and speech is perceived primarily based on the magnitude spectrum, the noisy signal phase may be used to obtain temporal-domain denoised speech.

As introduced above, the level of noise can be reduced by using the estimated SNR. It should be understood that the embodiment of the present disclosure is not limited to this example provided above, and any speech enhancement or noise reduction system can be applied to the embodiment of the present disclosure that will be described.

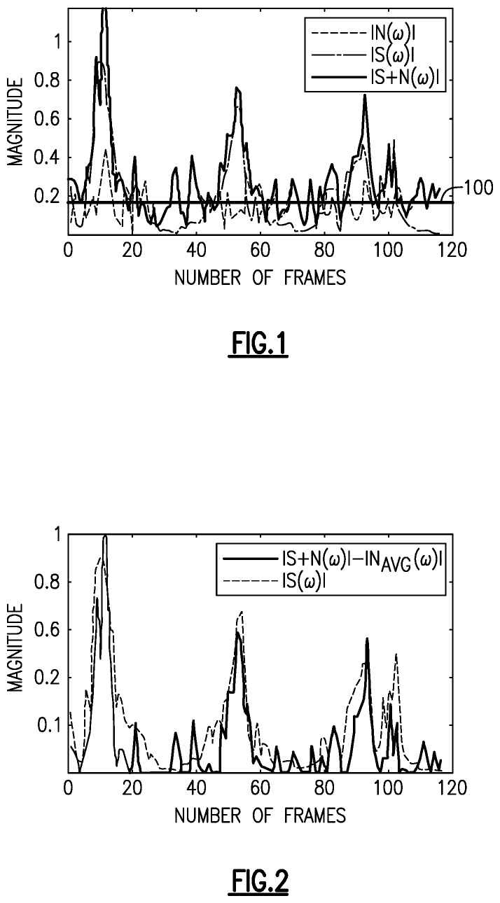

Generally, a speech recognizer extracts a feature vector from a frequency domain by performing a Fast Fourier Transform (FFT) on an input speech signal and recognizes the input speech signal by using stored speech data and the feature vector extracted from the input speech signal. However, when receiving a speech signal in which ambient noise is mixed, a speech recognition rate of the speech recognizer may be severely degraded. Specifically, a probability of an incorrect speech recognition result is high when a speech signal inputted in a process of recognizing a speech is distorted by external noise, in the speech recognizer. Therefore, a method of reducing a noise signal mixed in an input signal to increase a speech recognition rate is required. A conventional noise reduction apparatus of a speech recognizer employs a method of controlling a noise reduction rate with respect to all frequency components according to a speech-noise detection result, increasing the noise reduction rate when detecting a noise section, and lowering the noise reduction rate when detecting a speech section. In the conventional method of increasing the noise reduction rate with respect to the noise section a speech signal and a noise signal are detected in a time axis and an identical value is given to all frequencies even though a noise/speech rate is shown differently according to each frequency bandwidth in the speech section. As a result, in some examples effective noise reduction is difficult to provide despite an environmental change. On the other hand, in a conventional noise reduction method using spectrum correction and peak/valley accentuation, though Wiener filter scaling is performed by a speech absence probability and a probability estimated via statistical modeling is used, since speech and noise detection is performed on a time axis and an identical value is given to all frequencies, effective noise reduction despite environments with noise of various frequencies may not be provided. In a conventional method of estimating a noise spectrum, when it is assumed that the noise spectrum is not changed, an amplitude of the noise spectrum is estimated by a noise spectrum mean detected as shown in FIG. 1. However, in actuality, the amplitude of the noise spectrum fluctuates according to time as shown in FIG. 1.

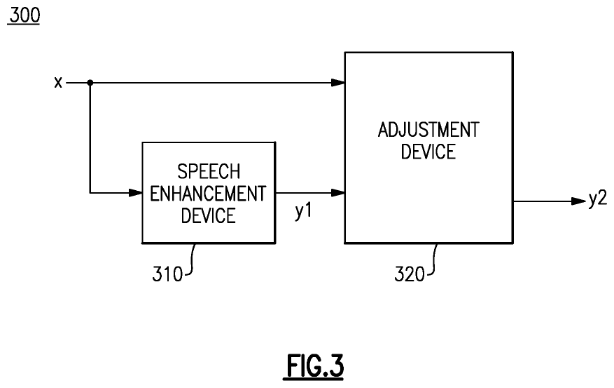

The conventional noise reduction apparatus configures and utilizes a Wiener filter to subtract the noise spectrum mean from an input signal. However, in the conventional noise reduction apparatus, an amplitude of a speech signal is in inverse proportion to a number of errors. Specifically, in the conventional noise reduction apparatus, most errors occur due to one-sidedly subtracting the noise spectrum mean from a part in which the amplitude of the speech signal is small. This result is shown in FIG. 2.

For most of the audio processing algorithms, the post-processing, such as the speech enhancement method, is used to enhance the quality of the audio signal. During the post-processing, the signal level can be reduced in order to increase the SNR. According to an embodiment, the SNR of the output signal of the post-processing algorithms for each of predetermined frequency ranges can be varied. In other words, the SNR of the output signal for each of different frequency ranges will be different from each other.

However, human hearing responds to audio differently at different SNRs. Therefore, the audio signals processed by the post processing system may sound un-natural due to different SNR depending on the frequency ranges.

Hereinafter, a speech enhancement system according to an embodiment of the present disclosure is provided. More specifically, after the post-processing which reduces the signal level in order to increase SNR per frequency ranges, the further adjustment of SNR for each of the frequency bands can be conducted. According to an embodiment, the adjustment of SNR may be achieved by mixing the raw signal and the processed signal.

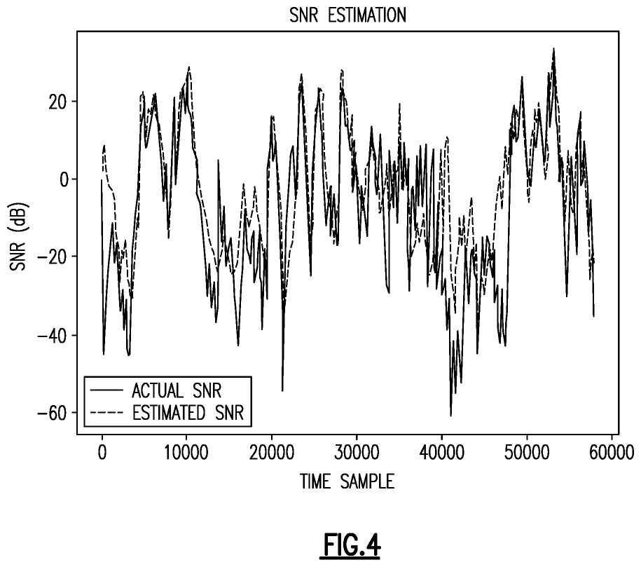

FIG. 3 is a schematic diagram of an advanced speech enhancement system 300 according to an embodiment of the present disclosure. As shown in FIG. 3, the advanced speech enhancement system 300 include a speech enhancement device 310 and an adjustment device 320.

The speech enhancement device 310 may be any type of known speech enhancement system or noise reduction system that is configured to reduce signal level depending on an estimated SNR in order to improve its SNR. In several examples, the signal level can be controlled for each of a plurality of predetermined frequency ranges independently. For example, the plurality of frequency ranges may be divided into low, mid, and high frequency bands. Thus, the SNR of the signal output from the speech enhancement device 310 may have different SNR for each of the plurality of frequency bands.

The speech enhancement device 310 may be configured to receive a first audio signal x. The first audio signal x may be a raw signal including a speech or voice of a user with some background noise. In this description, the speech or voice of the user may be referred to as target audio signal. The speech enhancement device 310 may be configured to increase SNR of the first audio signal. According to an embodiment, the SNR of the first audio signal may be increased independently for each of the plurality of frequency bands. The plurality of frequency bands may cover all frequencies that the target signal can possibly have.

The speech enhancement device 310 may be configured to execute at least a partial reduction of a signal level of the first audio signal. In other words, the reduction of the level of the first audio signal is a part of the procedures executed by the speech enhancement device 310. As described above, some sound components having a signal level below a certain threshold value are inaudible to a human. Thus, the speech enhancement device 310 may be configured to find an optimum amount of reduced signal from the original signal to improve SNR, while preventing the distortion of the target signal.

The speech enhancement device 310 may be configured to output a second audio signal y1. In this description, the second audio signal y1 may be referred to as a processed signal. The second audio signal y1 processed by the speech enhancement module 310 may have lower signal level than the original signal, i.e., the first audio signal x. The second audio signal y1 may have different SNRs for each of the predetermined frequency bands. Thus, the second audio signal y1 may sound un-natural to human hearings across different frequency bands.

The adjustment device 320 may be configured to adjust the SNR of the second audio signal y1 to be balanced throughout the predetermined frequency bands, by mixing up the second audio signal y1 with the first audio signal x based on the estimated SNR of each of the plurality of frequency bands.

The adjustment device 320 may be configured to receive the first audio signal x and the second audio signal y1. The adjustment device 320 may directly receive the first audio signal x from a source device (for example, a microphone) that collects the first audio signal x. However it is also possible that the adjustment device 320 may obtain the first audio signal x from the speech enhancement device 310.

The adjustment device 320 may be configured to compare the first audio signal x and the second audio signal y1. Based on the result of the comparison, the adjustment device 320 may determine the amount of signal removed from the first audio signal x through the speech enhancement device 310. That is, the adjustment device 320 may be configured to detect the level difference between the first audio signal x and the second audio signal y1. According to an embodiment, the amount of the removed signal in the second audio signal y1 may be different depending on the frequency bands. Therefore, the adjustment device 320 may calculate the level difference for each of the predetermined frequency bands, independently.

The adjustment device 320 may be configured to estimate the SNR for each of the plurality of frequency bands. More specifically, if the degree of the amount of removed signal is higher, then the adjustment device 320 may estimate the SNR of the signal (second signal y1) to have higher SNR.

The analysis result of high accuracy for this estimation is provided in FIG. 4. In FIG. 4, it is shown that there is no significant difference between the actual SNR and the estimated SNR of the second audio signal y1. In the speech enhancement device 310, the second audio signal y1 is generated to have improved SNR by removing some amount of signal from the first audio signal x. Therefore, SNRs for each of the frequency bands of the second audio signal y1 can be estimated based on the level difference of the signals, i.e., the first audio signal x and the second audio signal y1.

Returning back to FIG. 3, the adjustment device 320 may be configured to mix the first audio signal x and the second audio signal y1 based on a mixing ratio. In this description, the mixing ratio may be referred to as a wet-dry mix ratio. The raw or unprocessed audio signal is considered a dry signal, and the processed audio signal is considered the wet signal. Thus, according to an embodiment, the first audio signal x that is unprocessed may correspond to the dry signal, and the second audio signal y1 that is processed may correspond to the wet signal.

The adjustment device 320 may be configured to adjust the mixing ratio of the first audio signal x to the second audio signal y1 based on the estimated SNR independently for each of the plurality of frequency bands. In this manner, the adjustment device 320 may generate an output audio signal y2 having a balanced SNR throughout the plurality of frequency bands. It is construed that the balanced SNR means that the difference of SNR of the output audio signal y2 across the plurality of frequency bands remains within a specific range of values.

For example, the adjustment device 320 may be configured to increase a portion of the first audio signal x in a predetermined frequency band where a SNR of the second audio signal y1 is relatively higher than the other predetermined frequency bands. The adjustment device 320 may be configured to decrease a portion of the first audio signal in a predetermined frequency band where a SNR is relatively lower than the other predetermined frequency bands.

The adjustment device 320 may be configured to output the output signal y2. The output signal y2 may have a balanced SNR throughout the plurality of frequency bands. This helps to fill in parts of the spectrum that have been hit too hard by the processing block through the adjustment the wet-dry ratio that is used to mix the first audio signal with the second audio signal. Adjusting this ratio over time based on the estimated SNR makes the speech sound more natural and reduces the amount of distortion that audio processing can create in very low SNR environments.

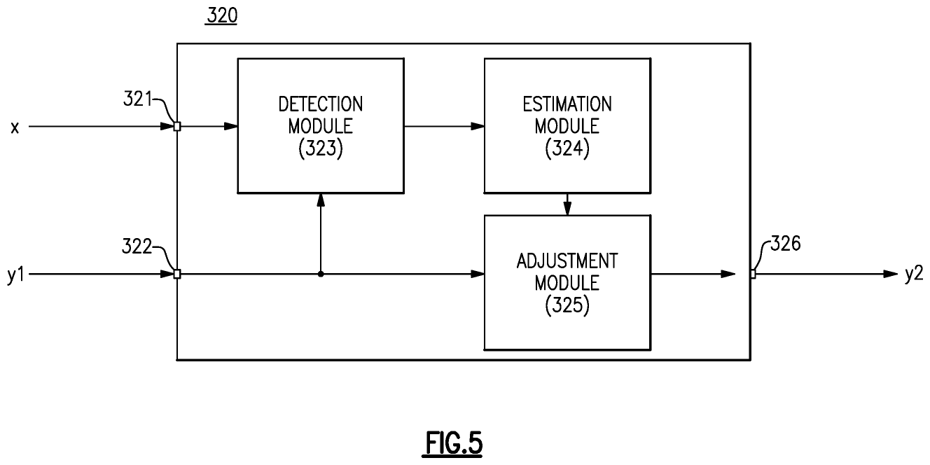

FIG. 5 is a schematic diagram of the adjustment device for an advanced audio processing system according to an embodiment of the present disclosure.

As shown in FIG. 5, the adjustment device 320 may include a first input node 321, a second input node 322, a detection module 323, an estimation module 324, an adjustment module 325, and an output node 326.

The first input node 321 may be configured to receive the first audio signal including a background noise. The second input node 322 may be configured to receive the second audio signal y1 with reduced signal level from the first audio signal x. The second input node 322 may receive the second audio signal y1 from a speech enhancement device 310. Thus, the second input node 322 may be suitable for being connected to the speech enhancement device 310. According to another embodiment, the first input node 321 and the second input node 322 may be incorporated into one node.

The detection module 323 may be configured to detect a level difference between the first audio signal and the second audio signal. The detection module 323 may be configured to compare the first audio signal x and the second audio signal y1. Based on the result of the comparison, the detection module 323 may determine the amount of signal removed from the first audio signal x through the speech enhancement device 310. According to an embodiment, the amount of the removed signal in the second audio signal y1 may be different depending on the frequency bands. Therefore, the detection module 323 may calculate the level difference for each of the predetermined frequency bands, independently.

The estimation module 324 may be configured to estimate the SNR for each of the plurality of frequency bands. More specifically, if the degree of the amount of removed signal is higher, then the estimation module 324 may estimate the SNR of the signal (second signal y1) to have higher SNR.

The adjustment module 325 may be configured to mix the first audio signal x and the second audio signal y1 based on a mixing ratio. In this description, the mixing ratio may be referred to as a wet-dry mix ratio. The raw or unprocessed audio signal is considered a dry signal, and the processed audio signal is considered the wet signal. Thus, according to an embodiment, the first audio signal x that is unprocessed may correspond to the dry signal, and the second audio signal y1 that is processed may correspond to the wet signal.

The adjustment module 325 may be configured to adjust the mixing ratio of the first audio signal x to the second audio signal y1 based on the estimated SNR independently for each of the plurality of frequency bands. In this manner, the adjustment module 325 may generate an output audio signal y2 having a balanced SNR throughout the plurality of frequency bands. It is construed that the balanced SNR means that the difference of SNR of the output audio signal y2 across the plurality of frequency bands remains within a specific range of values.

The output node 326 may be configured to output the output audio signal y2.

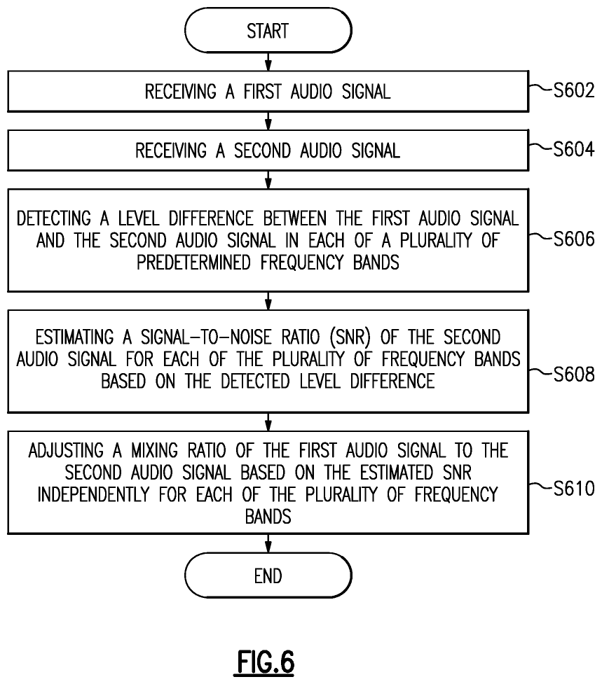

FIG. 6 is a flow chart illustrating a method for processing audio signal according to an embodiment of the present disclosure. The steps defined in the flow chart shown in FIG. 6 may be executed by the advanced speech enhancement system 300 shown in FIG. 3 or the adjustment device 320 shown in FIGS. 3 and 5.

In step S602, a first audio signal including a background noise may be received.

In step S604, a second audio signal with a reduced signal level from the first audio signal may be received.

In step S606, a level difference between the first audio signal and the second audio signal in each of a plurality of predetermined frequency bands may be detected.

In step S608, a signal-to-noise ratio (SNR) of the second audio signal for each of the plurality of frequency bands may be estimated based on the detected level difference.

In step S610, a mixing ratio of the first audio signal to the second audio signal may be adjusted based on the estimated SNR independently for each of the plurality of frequency bands to generate an output audio signal having a balanced SNR throughout the plurality of frequency bands.

FIG. 7 is an example computing environment 700 that can implement different method steps and algorithms described herein. The computing environment 700 according to an embodiment may be audio processors for mobile equipment and/or headphones/speakers. The computing environment 700 is shown in general form and is not intended to suggest a limitation on any specific use or functionality, as various examples or portions of examples herein can be implemented in general purpose or special purpose computing systems, including desktop computers, tablet computers, mobile devices, MCUs, PLCs, ASICS, FPGAS, CPLDs, etc. The computing environment 700 may include a core grouping of computing components 702 that includes one or more processing units 704, 706 and memory 708, 710. In some examples, processing units can be configured based on RISC or CSIC architectures, and can include one or more general purpose central processing units, application specific integrated circuits, graphics or co-processing units or other processors, such as floating point units or processors configured to enhance nonlinear regression analyses. In some examples, multiple core groupings of the computing components 702 can be distributed among ranging system modules, and various modules of software 712 can be implemented separately on separate ranging modules, including acoustic transmitters, acoustic receivers, for example.

The memory 708, 710 can be volatile memory (e.g., registers, cache, RAM), non-volatile memory (e.g., ROM, EEPROM, flash memory, etc.), or a combination of volatile and non-volatile memory. The memory 708, 710 is generally accessible by the processing units 704, 706 and can store the software 712 in the form computer-executable instructions that can be executed by the one or more processing units 704, 706 coupled to the memory 708, 710. The computing environment 700 can also include storage 714, input and output devices or ports 716, 718, and network communication connections 720. The storage 714 can be removable or non-removable and include magnetic media, CD-ROMS, DVDs, flash, or any other medium that can be used to store information in a non-transitory way and which can be accessed within the computing environment 700. In typical examples, the storage 714 can store instructions for the software 712 implementing one or more method steps and algorithms described herein.

Input and output devices and ports 716, 718 can include or be coupled to acoustic receivers, acoustic transmitters, acoustic signal converters, etc. Various interconnections can be included, such as one or more buses, controllers, routers, switches, etc., that can couple various components of the computing environment 700 and acoustic ranging system components together, such as acoustic receivers, acoustic transmitters, acoustic signal converters, acoustic preamplifiers/amplifiers, power sources, etc. The communication connections 720 and the input and output ports 716, 718 enable communication over a communication medium to various ranging system components, including other ranging system computing devices, and external system components and computing devices. The communication medium, such as electrical, optical, RF, etc., can convey information such as computer-executable instructions, acoustic transmit signals, acoustic receive signals, calibration signals, object detection signals, or other data in a modulated data signal. A modulated data signal can include signals having one or more of characteristics (e.g., frequency, amplitude, duty cycle, etc.) set or changed so as to encode information in the signal.

The software 712 can include one or more software modules or programs that can provide various commands associated with the steps described in FIG. 6.

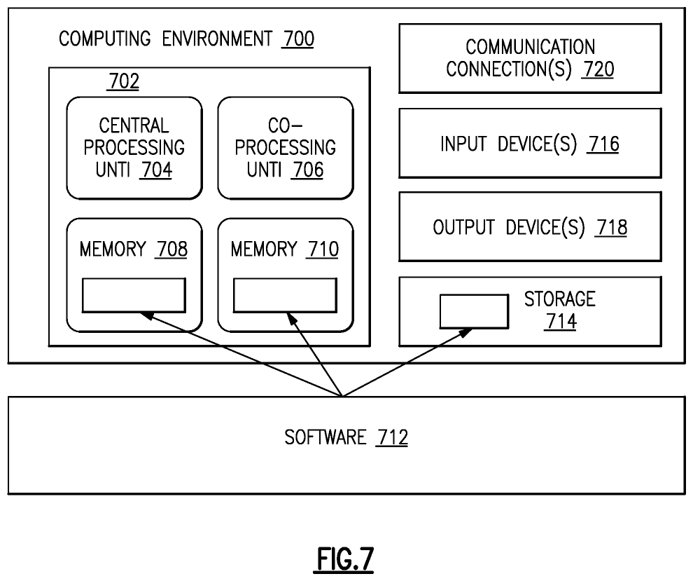

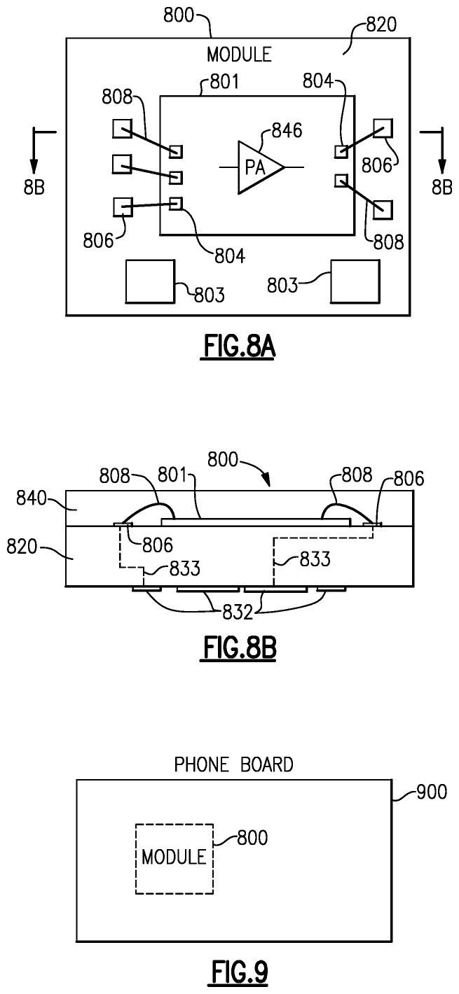

FIG. 8A is a schematic diagram of one embodiment of a packaged module 800. FIG. 8B is a schematic diagram of a cross-section of the packaged module 800 of FIG. 8A taken along the lines 8B-8B.

The packaged module 800 includes an IC or die 801, surface mount components 803, wirebonds 808, a package substrate 820, and encapsulation structure 840. The package substrate 820 includes pads 806 formed from conductors disposed therein. Additionally, the die 801 includes pads 804, and the wirebonds 808 have been used to electrically connect the pads 804 of the die 801 to the pads 806 of the package substrate 801.

The die 801 includes a speech enhancement system, which can be implemented in accordance with any of the embodiments herein.

The packaging substrate 820 can be configured to receive a plurality of components such as the die 801 and the surface mount components 803, which can include, for example, surface mount capacitors and/or inductors.

As shown in FIG. 8B, the packaged module 800 is shown to include a plurality of contact pads 832 disposed on the side of the packaged module 800 opposite the side used to mount the die 801. Configuring the packaged module 800 in this manner can aid in connecting the packaged module 800 to a circuit board such as a phone board of a wireless device. The example contact pads 832 can be configured to provide RF signals, bias signals, power low voltage(s) and/or power high voltage(s) to the die 801 and/or the surface mount components 803. As shown in FIG. 8B, the electrically connections between the contact pads 832 and the die 801 can be facilitated by connections 833 through the package substrate 820. The connections 833 can represent electrical paths formed through the package substrate 820, such as connections associated with vias and conductors of a multilayer laminated package substrate.

In some embodiments, the packaged module 800 can also include one or more packaging structures to, for example, provide protection and/or facilitate handling of the packaged module 800. Such a packaging structure can include overmold or encapsulation structure 840 formed over the packaging substrate 820 and the components and die(s) disposed thereon.

It will be understood that although the packaged module 800 is described in the context of electrical connections based on wirebonds, one or more features of the present disclosure can also be implemented in other packaging configurations, including, for example, flip-chip configurations.

FIG. 9 is a schematic diagram of one embodiment of a phone board 900. The phone board 900 includes the packaged module 800 shown in FIGS. 8A and 8B attached thereto. Although not illustrated in FIG. 9 for clarity, the phone board 900 can include additional components and structures.

### Applications

Some of the embodiments described above have provided examples in connection with wireless devices or mobile phones. However, the principles and advantages of the embodiments can be used for any other systems or apparatus that have needs for speech processing systems.

Such speech processing systems can be implemented in various electronic devices. Examples of the electronic devices can include, but are not limited to, consumer electronic products, parts of the consumer electronic products, electronic test equipment, etc. Examples of the electronic devices can also include, but are not limited to, memory chips, memory modules, circuits of optical networks or other communication networks, and disk driver circuits. The consumer electronic products can include, but are not limited to, a mobile phone, a telephone, a television, a computer monitor, a computer, a hand-held computer, a personal digital assistant (PDA), a microwave, a refrigerator, an automobile, a stereo system, a cassette recorder or player, a DVD player, a CD player, a VCR, an MP3 player, a radio, a camcorder, a camera, a digital camera, a portable memory chip, a washer, a dryer, a washer/dryer, a copier, a facsimile machine, a scanner, a multi-functional peripheral device, a wrist watch, a clock, etc. Further, the electronic devices can include unfinished products.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the inventive aspects provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method for processing audio signals, the method comprising:
receiving a first audio signal including a background noise;
receiving a second audio signal with a reduced signal level from the first audio signal;
detecting a level difference between the first audio signal and the second audio signal in each of a plurality of predetermined frequency bands;
estimating a signal-to-noise ratio (SNR) of the second audio signal for each of the plurality of frequency bands based on the detected level difference; and
adjusting a mixing ratio of the first audio signal to the second audio signal based on the estimated SNR independently for each of the plurality of frequency bands to generate an output audio signal having a balanced SNR throughout the plurality of frequency bands.

2. The method of claim 1 further comprising outputting the output signal with the adjusted mixing ratio for each of the plurality of frequency bands.

3. The method of claim 1 wherein the step of adjusting the mixing ratio includes increasing a portion of the first audio signal in a predetermined frequency band where a SNR of the second audio signal is relatively higher than the other predetermined frequency bands.

4. The method of claim 1 wherein the step of adjusting the mixing ratio includes decreasing a portion of the first audio signal in a predetermined frequency band where a SNR is relatively lower than the other predetermined frequency bands.

5. The method of claim 1 wherein the second audio signal is obtained by a speech enhancement device that enables to reduce the background noise included in the first audio signal.

6. The method of claim 1 wherein the step of adjusting the mixing ratio is performed periodically according to a pre-configured period of time.

7. The method of claim 1 wherein the first audio signal is a raw speech signal of a user.

8. An adjustment device for an advanced speech enhancement system, the adjustment device comprising:
a first input node configured to receive a first audio signal including a background noise;
a second input node configured to receive a second audio signal with a reduced signal level from the first audio signal;
a detection module configured to detect a level difference between the first audio signal and the second audio signal in each of a plurality of predetermined frequency bands;
an estimation module configured to estimate a signal-to-noise ratio (SNR) of the second audio signal for each of the plurality of frequency bands based on the detected level difference; and
an adjustment module configured to adjust a mixing ratio of the first audio signal to the second audio signal based on the estimated SNR independently for each of the plurality of frequency bands to generate an output audio signal having a balanced SNR throughout the plurality of frequency bands.

9. The device of claim 8 further comprising an output node configured to output the output signal with the adjusted mixing ratio for each of the plurality of frequency bands.

10. The device of claim 8 wherein the adjustment module is configured to increase a portion of the first audio signal in a predetermined frequency band where a SNR of the second audio signal is relatively higher than the other predetermined frequency bands.

11. The device of claim 8 wherein the adjustment module is configured to decrease a portion of the first audio signal in a predetermined frequency band where a SNR is relatively lower than the other predetermined frequency bands.

12. The device of claim 8 wherein the second input node is suitable for being connected to a speech enhancement device that enables to reduce the background noise included in the first audio signal such to receive the second audio signal.

13. The device of claim 8 wherein the adjustment device is configured to adjust the mixing ratio periodically according to a pre-configured period of time.

14. The device of claim 8 wherein the first audio signal is a raw speech signal of a user.

15. A advanced speech enhancement system comprising:
a speech enhancement device configured to receive the first audio signal and output the second audio signal having improved SNR; and
an adjustment device including a first input node configured to receive a first audio signal including a background noise, a second input node configured to receive a second audio signal with a reduced signal level from the first audio signal, a detection module configured to detect a level difference between the first audio signal and the second audio signal in each of a plurality of predetermined frequency bands, a estimation module configured to estimate a signal-to-noise ratio (SNR) of the second audio signal for each of the plurality of frequency bands based on the detected level difference, and an adjustment module configured to adjust a mixing ratio of the first audio signal to the second audio signal based on the estimated SNR independently for each of the plurality of frequency bands to generate an output audio signal having a balanced SNR throughout the plurality of frequency bands.

16. The speech enhancement system of claim 15 the adjustment device further comprising an output node configured to output the output signal with the adjusted mixing ratio for each of the plurality of frequency bands.

17. The speech enhancement system of claim 15 wherein the adjustment module of the adjustment device is configured to increase a portion of the first audio signal in a predetermined frequency band where a SNR of the second audio signal is relatively higher than the other predetermined frequency bands.

18. The speech enhancement system of claim 15 wherein the adjustment module of the adjustment device is configured to decrease a portion of the first audio signal in a predetermined frequency band where a SNR is relatively lower than the other predetermined frequency bands.

19. The speech enhancement system of claim 15 wherein the second input node of the adjustment device is connected to the speech enhancement device.

20. The speech enhancement system of claim 15 wherein the adjustment device is configured to adjust the mixing ratio periodically according to a pre-configured period of time.
